(19) United States
(12) Patent Application Publication
(10) Pub. No.: US 2009/0181218 A1
(43) Pub. Date: Jul. 16, 2009

(54) Conductive pattern and method of forming thereof

(76) Inventors: Jung-Ho Park, Daejeon Metropolitan Ciry (KR); Jong-Taik Lee, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/318,871

(22) Filed: Jan. 9, 2009

(30) Foreign Application Priority Data
Jan. 11, 2008 (KR) 2008-0003515

(51) Int. Cl. B32B 3/00; B05D 5/12

(52) U.S. Cl. 428/195.1; 427/98.4

(57) ABSTRACT

The present invention relates to a conductive pattern and a method for forming the conductive pattern, and more particularly, to a method for forming a conductive pattern, which comprises the steps of 1) preparing a substrate; 2) forming a first pattern by printing a first composition that includes an adhesion promoter and a solvent on the substrate; 3) forming a second pattern by printing a second composition that includes a conductive particle and a solvent on the first pattern; and 4) sintering the first pattern and the second pattern. The method for forming the conductive pattern according to the present invention may improve an adhesion property between a pattern and a substrate and may form a fine pattern having high resolution without formation of bank on a hydrophobic substrate.

### BACKGROUND OF THE INVENTION

1. Field of the Invention

The present invention relates to a conductive pattern and a method for forming the conductive pattern.

This application claims priority from Korean Patent Application No. 10-2008-0003515 filed on Jan. 11, 2008 in the KIPO, the disclosure of which is incorporated herein by reference in its entirety.

2. Description of the Related Art

In transparent substrates for display and circuit substrates for electronic parts that have recently been used, the formation of the conductive pattern is necessary. The conductive pattern is mainly formed by a photosensitive paste method or a photo etching method.

In the photosensitive paste method, after the photosensitive electrode paste is coated by using a screen printer, UV exposure is performed by using a photomask. At this time, a portion that is subjected to the UV exposure is crosslinked, thus it is not etched by an etching solution such as an alkali aqueous solution, and a portion that is not subjected to the UV exposure is not crosslinked, thus it is etched by an etching solution. Finally, a specific electrode pattern is formed. However, the formation of the electrode by using the photosensitive electrode paste is disadvantageous in terms of the degree of precision of pitch and control of the electrode width.

In the photoetching method, the electrode is mainly formed by an entire surface coating or deposition/etching process. However, the electrode forming method by the vacuum deposition is problematic in that a process time is long, the costs of the thin film forming device and the material are high, and environmental pollution may occur when etching is carried out.

Accordingly, currently, a technology that replaces a known process by an inkjet printing has been proposed. According to the inkjet technology, since material is discharged to a necessary place, unnecessary waste of the material is reduced, and the process may be simplified into a direct spray process without a mask.

In Korean Unexamined Patent Application Publication No. 2005-0040511, in order to improve an adhesion property between ink and the substrate, an absorbable polymer layer is printed on the substrate. Through the heat treatment, the absorbable polymer layer that is attached to the substrate is removed, but in this case, while the polymer layer is removed, the conductive pattern may be lifted off.

Meanwhile, Japanese Unexamined Patent Application Publication No. Hei 11-273557 discloses that in order to prevent flow of ink and improve an adhesion property, the surface of the substrate is processed to have a rough surface, thus obtaining a pattern having the high degree of precision. However, in this method, by roughly processing the entire substrate, it is impossible to apply it to substrates for display that require the high transparency, and in the case of thin film soft substrate, there is a difficulty in processing.

In a technology for forming wire by an inkjet type using a conductive ink, the shape of wire is determined according to a state of substrate. In particular, currently, in the case of wire pattern that is used for small-sized and highly integrated electronic devices, a line width in the range of several to several tens pm is required. In a known inkjet process, by coating an absorbable polymer layer on the substrate, an adhesion property of ink and a line width are improved, or by physically or chemically roughly processing the substrate, an adhesion property and a line width are improved. However, in the case of the polymer layer coating, in a sintering process, a conductive pattern may be lifted off, and in the case of when a substrate is roughly processed, the transparency of the substrate is reduced. In the case of the thin film soft substrate, there is a problem in processing. In addition, if it is subjected to this processing, since an additional process is used in addition to the inkjet process, there is a problem in that the cost is increased.

In order to improve this process, a method where an adhesion promoter is added to ink has been studied. However, in the case of when the adhesion promoter is added to the ink, there are problems in that the viscosity of ink is increased and a spray characteristic is reduced.

### SUMMARY OF THE INVENTION

In order to solve the above problems, it is an object of the present invention to provide a method for forming a conductive pattern, in which an adhesion property of a pattern is improved even on a hydrophobic substrate and a resolution of the conductive pattern is increased to form a fine pattern, and a conductive pattern that is produced by using the same.

In order to accomplish the above object, the present invention provides a method for forming a conductive pattern, which comprises the steps of 1) preparing a substrate; 2) forming a first pattern by printing a first composition that includes an adhesion promoter and a solvent on the substrate; 3) forming a second pattern by printing a second composition that includes a conductive particle and a solvent on the first pattern; and 4) sintering the first pattern and the second pattern.

In addition, the present invention provides a conductive pattern which comprises a) a substrate; b) a first pattern that is printed on the substrate and includes an adhesion promoter; and c) a second pattern that is printed on the first pattern and includes a conductive particle.

A method for forming a conductive pattern according to the present invention may improve an adhesion property between a substrate and a pattern while the conductive pattern is formed by an inkjet process, may produce the conductive pattern having the high degree of precision in the range of several to several tens pm to improve the quality of conductive pattern, and may be applied to various substrates. In addition, the process may be simplified as compared to a known photolithography process and a process cost may be reduced.

### DESCRIPTION OF THE DRAWINGS

FIGS. 1 and 2 are views that schematically illustrate the formation of a first pattern by printing a first composition on a substrate while a conductive pattern according to the present invention is formed;

FIGS. 3 and 4 are views that schematically illustrate the formation of a second pattern by printing a second composition on the first pattern while a conductive pattern according to the present invention is formed; and

FIGS. 5 and 6 are views that illustrate adhesion property test results of Examples and Comparative Examples according to the present invention, in which a right side is a side that is subjected to an adhesion property test and a left side is a side that is not subjected to the test when the dotted line of FIG. 5 is considered a boundary.

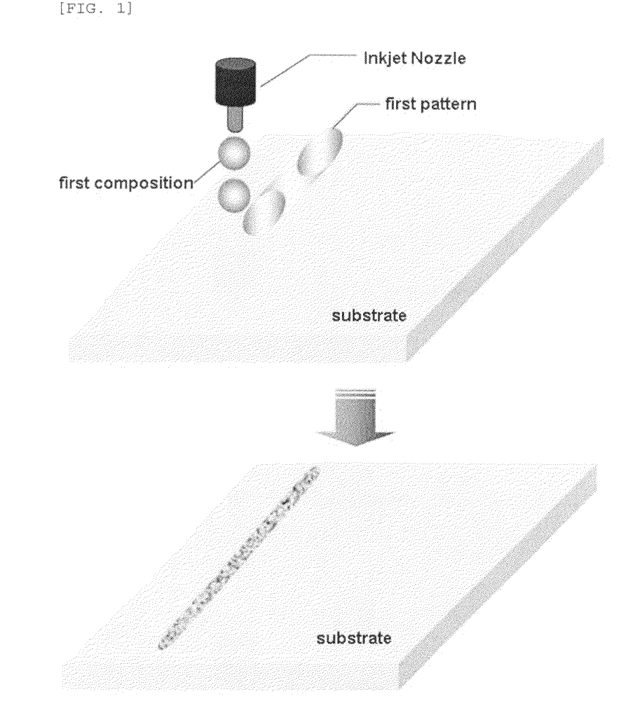

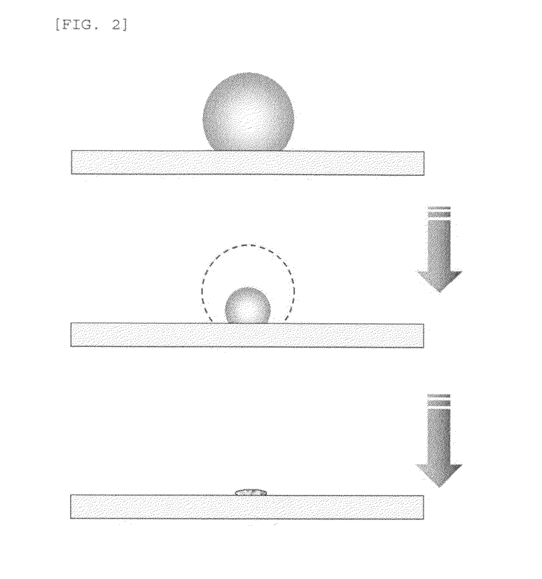

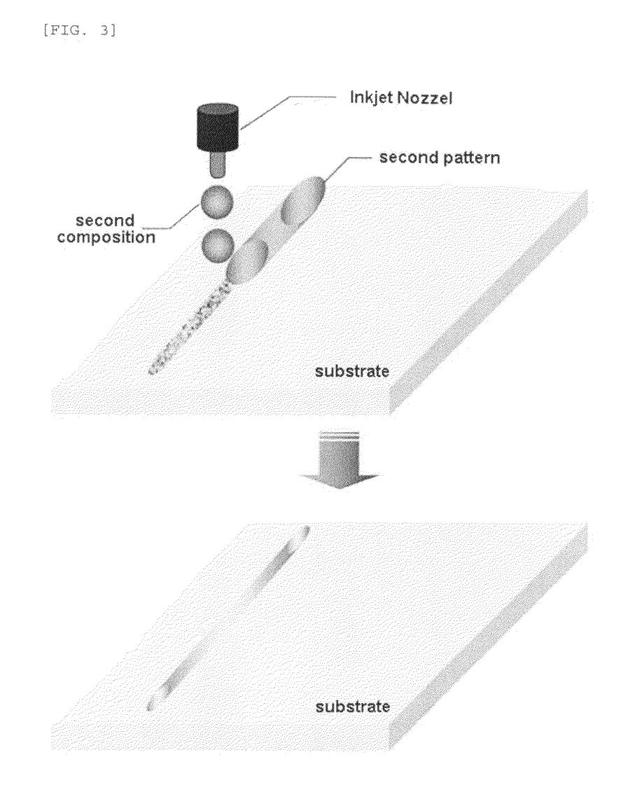

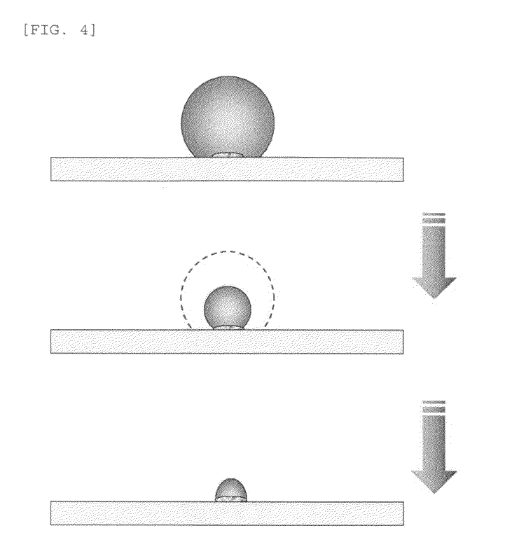

### DESCRIPTION OF THE PREFERRED EMBODIMENTS

In the present invention, in order to improve an adhesion property between a substrate and a pattern and to increase the degree of precision of the conductive pattern, a method using two different compositions is used. Each composition may be classified into a first composition that maximizes an adhesion property between the substrate and the pattern and reduces an amount of remaining particles and a second composition that maximizes the conductivity. By printing the first composition on the substrate to attach the first composition to the substrate, and by printing the second composition thereon, a linear conductive pattern that has excellent adhesion property and a fine line width may be formed.

In detail, a method for forming a conductive pattern according to the present invention comprises the steps of 1) preparing a substrate; 2) forming a first pattern by printing a first composition that includes an adhesion promoter and a solvent on the substrate; 3) forming a second pattern by printing a second composition that includes a conductive particle and a solvent on the first pattern; and 4) sintering the first pattern and the second pattern.

In the method for forming a conductive pattern according to the present invention, the substrate of step 1) is not particularly limited, and a glass substrate, a plastic substrate and the like that may be applied to substrates for display, substrates for electronic parts and the like may be used.

In step 1), a process for washing the substrate, a process for performing pretreatment against the substrate and the like may be included. The washing method and the pretreatment method for the substrate may be appropriately selected according to the kind of the substrate or the printing composition. In more detail, the washing of the substrate may be carried out by plasma cleaning, and the pretreatment of the substrate may be carried out by the hydrophobic substrate treatment process, but they are not limited thereto.

In particular, in order to form a conductive pattern having the fine line width, the hydrophobic substrate treatment to the substrate of step 1) may be carried out. The hydrophobic substrate treatment may be carried out by using the method that is known in the art, and in more detail, a method such as plasma treatment, SAM coating, surfactant coating and the like may be used.

As described above, in the case of when the substrate is subjected to the hydrophobic substrate treatment, a known composition that includes conductive particles is problematic in that since a line breakage occurs on the hydrophobic substrate or a phenomenon where liquid drops of the composition are partially agglomerated occurs, the shape of the finally formed conductive pattern is not uniform, and a phenomenon where after the sintering, the conductive pattern is separated from the substrate occurs, thus the conductivity is significantly reduced. However, in the present invention, by sequentially printing the first composition and second composition having a predetermined composition on the substrate, the adhesion property between the substrate and the pattern may be improved and the conductive pattern having the high degree of precision may be formed.

In the method for forming the conductive pattern according to the present invention, the first composition of step 2) may include 0.1 to 35 wt % of the adhesion promoter and 65 to 99.9 wt % of the solvent.

In the present invention, the adhesion promoter means a component that is capable of improving an adhesion property between the pattern and the substrate. The adhesion promoter may be selected according to the kind of the substrate or the composition of the pattern. The adhesion promoter preferably has a contact angle of 30° or less to the substrate while the adhesion promoter is dissolved in the solvent, and more preferably has a contact angle of 20° or less. In addition, the adhesion promoter preferably has a melting point of 300° C. or less and more preferably 200° C. or less while it is sintered.

Since the first composition includes the adhesion promoter, the adhesion property between the substrate and the pattern may be improved. In addition, by adding an additive that is suitable to surface characteristics of the substrate in the composition, the substrate may be made specific. However, the adhesion promoter according to the present invention does not related to the moisture absorption property, and it is more preferable that the adhesion promoter does not have the moisture absorption property in consideration of cost.

Detailed examples of the adhesion promoter may include glass frit, silica beads, polyethylene oxide, polyethylene glycol, cellulose polymers, and a mixture thereof, but are not limited thereto. In particular, in the case of when the surface of the substrate is made of glass, an additive that is similar to the surface of the substrate, such as the glass frit or the silica beads may be added into the first composition to make the substrate specific. As the adhesion promoter, one or more may be used.

The first composition may further include a conductive particle, but it is preferable that the content thereof is in the range of 0.1 to 10 wt %. In the case of when the first composition includes the conductive particle, it is preferable that the first composition includes 0.1 to 10 wt % of the conductive particle, 0.1 to 35 wt % of the adhesion promoter and 55 to 99.8 wt % of the solvent. In the case of when the content of the conductive particle is more than 10 wt %, it is difficult to perform the printing by an increase in viscosity. However, in the case of when the first composition includes 0.1 wt % or more and 10 wt % or less of the conductive particle, conductive particles in the first composition are connected to the conductive particles in the second pattern when the sintering is performed while the viscosity is not increased, thus the conductivity may be improved and the adhesion property between the first pattern and the second pattern may be improved. In addition, in the case of when the first composition includes the conductive particles in the above range, protrusions are formed on the surface of the first pattern that is formed by printing the first composition and drying it, thus the surface has prominences and depressions. Accordingly, the adhesion property between the first pattern and the second pattern may be improved.

Detailed examples of the conductive particles may include Ag, Cu, Au, Cr, Al, W, Zn, Ni, Fe, Pt, Pb, an alloy thereof, a mixture thereof and the like, but are not limited thereto.

The particle diameter of the conductive particle may be 500 nm or less, preferably 200 nm or less, and more preferably 100 nm or less. The particle diameter of the conductive particle is preferably 0.1 nm or more and more preferably 5 nm or more.

Detailed examples of the solvent may include water, acetone, methyl ethyl ketone, methyl isobutyl ketone, methyl cellosolve, ethyl cellosolve, tetrahydrofurane, 1,4-dioxane, ethyleneglycol dimethyl ether, ethyleneglycol diethyl ether, propyleneglycol methyl ether, propyleneglycol dimethyl ether, propyleneglycol diethyl ether, chloroform, methylene chloride, 1,2-dichloroethane, 1,1,1-trichloroethane, 1,1,2-trichloroethane, 1,1,2-trichloroethene, hexane, heptane, octane, cyclohexane, benzene, toluene, xylene, methanol, ethanol, isopropanol, propanol, butanol, t-butanol, cyclohexanone, propyleneglycol methyl ether acetate, propyleneglycol ethyl ether acetate, 2-methoxybutyl acetate, ethyl 3-ethoxy propionate, ethyl cellosolveacetate, methyl cellosolveacetate, butyl acetate, methylethylketone, methylisobutylketone, ethylene glycol monomethyl ether, γ-butyllactone, N-methylpyrollidone, dimethylformamide, tetramethylsulfone, ethyleneglycol acetate, ethyl ether acetate, ethyl lactate, polyethyleneglycol, cyclohexanone, a mixture thereof and the like, but are not limited thereto.

The preferable viscosity of the first composition is in the range of 0.5 to 40 cps.

The first composition may further include an additive that is known in the art. Examples of the additive include a dispersing agent, a surfactant and the like, but are not limited thereto.

A method for printing the first composition on the substrate may use an inkjet method.

In a method for forming the conductive pattern according to the present invention, after step 2), a step for drying the first pattern that is formed on the substrate may be further included. The drying may be carried out at a temperature in the range of 25 to 150° C. for 10 min or more, but not limited thereto.

In the case of when the first composition includes the conductive particles in the above range, by step 2) and if necessary, by the drying step of the first pattern, from the first composition having the excellent adhesion property between the substrate and the pattern, protrusions including the conductive particles are formed on the substrate. In general, in the case of when the surface is rough rather than smooth, the contact area of the composition in the same area is increased, and thus the adhesion property of the composition is increased. That is, since the above protrusion that includes the conductive particles acts as a kind of guide line of ink on the surface of the hydrophobic substrate while the second composition is printed, a fine conductive pattern may be easily formed.

In the method for forming the conductive pattern according to the present invention, the second composition of step 3) may include 10 to 90 wt % of the conductive particles and 10 to 90 wt % of the solvent.

Detailed examples of the conductive particles and solvent that are included in the second composition may be examples of the conductive particles and solvent that are includes in the first composition.

In the second composition, since the adhesion promoter that suppresses the dispersibility and is a factor of an increase in viscosity in a known composition that is used to form the conductive pattern is excluded, stable dispersion may be maintained, constitution of the composition may be simplified, and the viscosity of the composition may be freely controlled. In addition, the dispersibility and the conductivity of the composition may be increased and an effect by the surface characteristic of the substrate may be excluded since the printing is performed on the first pattern printed on the substrate.

The preferable viscosity of the second composition is in the range of 0.5 to 40 cps.

In the second composition, if necessary, an additive such as a dispersing agent, a surfactant and the like may be added.

In the method for forming the conductive pattern according to the present invention, in the case of when the drying step of the first pattern is omitted, step 2) and step 3) may be simultaneously carried out by using a plurality of inkjet heads. In this case, if necessary, by heating the substrate, the adhesion property of the first pattern on the substrate may be increased.

When the first composition and second composition are printed, the printing amount of each composition may be depend on the shape of the desired pattern or the purpose. For example, when the conductive wire is formed, it is preferable that the amount of the first composition is not more than the amount of the second composition.

After step 3), a step of drying the second pattern may be further included.

In the method for forming the conductive pattern according to the present invention, step 4) is a step where the first pattern and second pattern formed on the substrate are sintered. The sintering may be carried out at a temperature of 200° C. or more for 10 min or more, but is not limited thereto.

In addition, the conductive pattern according to the present invention includes a) a substrate, b) a first pattern that is printed on the substrate and includes the adhesion promoter, and c) a second pattern that is printed on the first pattern and includes the conductive particle.

The conductive pattern according to the present invention has the excellent adhesion property to the substrate and the high degree of precision of several to several tens μm.

The thickness or the width of the first pattern and second pattern may depend on the shape of the desired pattern or the purpose. For example, when the conductive wire is formed, it is preferable that the thickness of the first pattern is not higher than the thickness of the second pattern.

The conductive pattern according to the present invention may be applied to display devices, circuits for electronic parts and the like, but is not limited thereto.

A better understanding of the present invention may be obtained in light of the following preferable Examples which are set forth to illustrate, but are not to be construed to limit the present invention.

### EXAMPLE

On the substrate, the first composition that included 70 wt % of the solvent that included propylene glycol propyl ether (PGPE), ethylene glycol (EG), and glycerol, 5 wt % of Ag NP (Ag nano particle), and 25 wt % of PEG600 acting as the adhesion promoter was printed. After the first composition was dried, on the formed pattern, the second composition that included 50 wt % of the solvent that included propylene glycol propyl ether (PGPE), ethylene glycol (EG), and glycerol and 50 wt % of Ag NP (Ag nano particle) was printed. After the sintering was carried out at 560° C. for 4 hours, the adhesion property test was performed by using the 3M tape, and it was confirmed that there was no damage to the conductive pattern and the adhesion property is excellent.

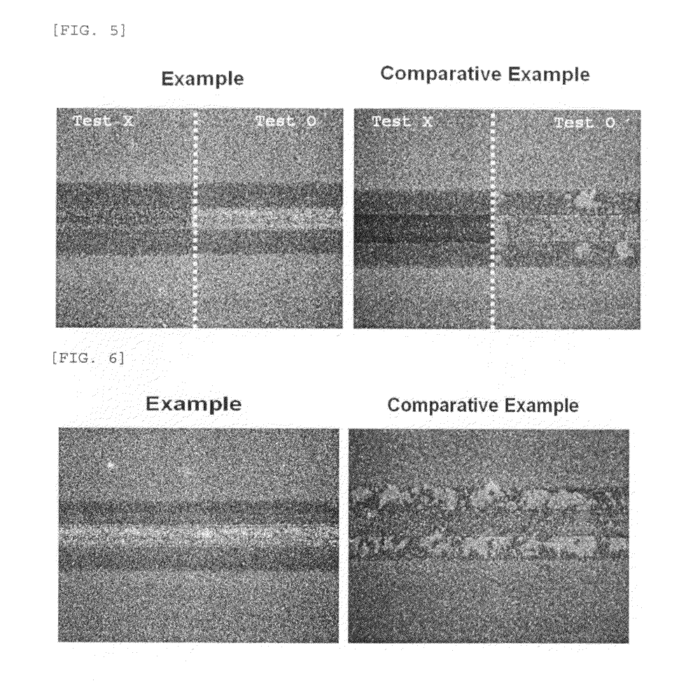

The results are shown in FIGS. 5 and 6.

### COMPARATIVE EXAMPLE

On the substrate, the composition that included 50 wt % of the solvent that included propylene glycol propyl ether (PGPE), ethylene glycol (EG), and glycerol, and 50 wt % of Ag NP (Ag nano particle) was printed. Through this, the conductive pattern was formed on the substrate. Like Example, after the sintering was carried out at 560° C. for 4 hours, the adhesion property test was performed. However, it was confirmed that since the adhesion property was low, a portion of the conductive pattern was destroyed.

The results are shown in FIGS. 5 and 6.

What is claimed is:

1. A method for forming a conductive pattern, the method comprising the steps of:
1) preparing a substrate; and
2) forming a first pattern by printing a first composition that includes an adhesion promoter and a solvent on the substrate;
3) forming a second pattern by printing a second composition that includes a conductive particle and a solvent on the first pattern; and
4) sintering the first pattern and the second pattern.

2. The method for forming a conductive pattern as set forth in claim 1, wherein the substrate of step 1) is a glass substrate or plastic substrate.

3. The method for forming a conductive pattern as set forth in claim 1, wherein the step 1) includes a hydrophobic substrate treating process.

4. The method for forming a conductive pattern as set forth in claim 1, wherein the first composition of step 2) includes 0.1 to 35 wt % of the adhesion promoter and 65 to 99.9 wt % of the solvent.

5. The method for forming a conductive pattern as set forth in claim 1, wherein the first composition of step 2) further includes a conductive particle.

6. The method for forming a conductive pattern as set forth in claim 5, wherein the first composition of step 2) includes 0.1 to 10 wt % of the conductive particle, 0.1 to 35 wt % of the adhesion promoter and 55 to 99.8 wt % of the solvent.

7. The method for forming a conductive pattern as set forth in claim 5, wherein the conductive particle of step 2) or step 4) includes one or more selected from the group consisting of Ag, Cu, Au, Cr, Al, W, Zn, Ni, Fe, Pt, Pb, and an alloy thereof.

8. The method for forming a conductive pattern as set forth in claim 1, wherein the adhesion promoter of step 2) has a contact angle of 30° or less with the substrate while the adhesion promoter is dissolved in the solvent.

9. The method for forming a conductive pattern as set forth in claim 1, wherein the adhesion promoter of step 2) includes one or more selected from the group consisting of glass frits, silica beads, polyethylene oxide, polyethylene glycol, and cellulose polymers.

10. The method for forming a conductive pattern as set forth in claim 1, wherein the solvent of step 2) or step 3) includes one or more selected from the group consisting of water, acetone, methyl ethyl ketone, methyl isobutyl ketone, methyl cellosolve, ethyl cellosolve, tetrahydrofurane, 1,4-dioxane, ethyleneglycol dimethyl ether, ethyleneglycol diethyl ether, propyleneglycol methyl ether, propyleneglycol dimethyl ether, propyleneglycol diethyl ether, chloroform, methylene chloride, 1,2-dichloroethane, 1,1,1-trichloroethane, 1,1,2-trichloroethane, 1,1,2-trichloroethene, hexane, heptane, octane, cyclohexane, benzene, toluene, xylene, methanol, ethanol, isopropanol, propanol, butanol, t-butanol, cyclohexanone, propyleneglycol methyl ether acetate, propyleneglycol ethyl ether acetate, 2-methoxybutyl acetate, ethyl 3-ethoxy propionate, ethyl cellosolveacetate, methyl cellosolveacetate, butyl acetate, methylethylketone, methylisobutylketone, ethylene glycol monomethyl ether, γ-butyllactone, N-methylpyrollidone, dimethylformamide, tetramethylsulfone, ethyleneglycol acetate, ethyl ether acetate, ethyl lactate, polyethyleneglycol, and cyclohexanone.

11. The method for forming a conductive pattern as set forth in claim 1, further comprising:
after step 2), drying the first pattern.

12. The method for forming a conductive pattern as set forth in claim 1, wherein the second composition of step 3) includes 10 to 90 wt % of the conductive particle and 10 to 90 wt % of the solvent.

13. The method for forming a conductive pattern as set forth in claim 1, wherein the printing of the first composition of step 2) and the printing of the second composition of step 3) are performed by an inkjet method.

14. A conductive pattern comprising:
a) a substrate;
b) a first pattern that is printed on the substrate and includes an adhesion promoter; and
c) a second pattern that is printed on the first pattern and includes a conductive particle.

15. The conductive pattern as set forth in claim 14, wherein the first pattern further includes a conductive particle.

16. The conductive pattern as set forth in claim 14, wherein the first pattern has a surface unevenness at an interface with the second pattern.
